(19) United States
(12) Patent Application Publication
(10) Pub. No.: US 2014/0197633 A1
(43) Pub. Date: Jul. 17, 2014

(54) Fitting for Joining Tubes and Method of Joining Tubes

(71) Applicant: Cerro Flow Products LLC, Sauget, IL (US)

(72) Inventors: Forrest Nixon, Columbia, IL (US); Michael J. Wilson, Eureka, MO (US); Bradley Arment, Shelbyville, MO (US); Steven L. Baue, Sparta, IL (US); Michael J. Duggan, St. Louis, MO (US)

(21) Appl. No.: 14/152,300

(22) Filed: Jan. 10, 2014

Related U.S. Application Data
(60) Provisional application No. 61/751,613, filed on Jan. 11, 2013.

(51) Int. Cl. F16L 13/14

(52) U.S. Cl. CPC F16L 13/142
USPC 285/343; 285/382; 29/516

(57) ABSTRACT

A crimp fitting comprises a female socket that is configured to be crimped to an end portion of a hard tube. The socket comprises an annealed annular wall that has an inner cylindrical surface portion and at least one annular sealing portion. The cylindrical surface portion lies axially between the socket opening and the annular sealing portion, and has a diameter matched to the OD of the tube. The annular sealing portion has an innermost diameter that is greater than the diameter of the cylindrical surface portion. As the end of the tube is inserted into the socket, the tube cannot slideably contact the annular sealing portion. Thus, the annular sealing portion will not be damaged by the insertion of the tube. Thereafter, the annular sealing portion is radially crimped and ultimately contacts and deforms a portion of the tube in a manner creating interlocking geometry and a pressure seal.

### CROSS-REFERENCE TO RELATED APPLICATIONS

This application is the non-provisional patent application of U.S. Provisional App. Ser. No. 61/751,613, filed Jan. 11, 2013, which is currently pending.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention pertains to fittings for joining pressurized tubes to each other. More particularly, the present invention pertains to metal crimp fittings that are configured to create metal-to-metal seals that can maintain a pressure seal at temperatures that exceed the working temperatures of most polymeric O-rings.

2. General Background

As discussed in U.S. patent application Ser. No. 13/714,002, filed Dec. 13, 2012 (which, in its entirety, is hereby incorporated into the present application by reference), metal crimp fittings can be used to join metal tubes together in a manner such that the joints are leak free at gauge pressures in excess of 2,000 psi (13.8 MPa). Such fittings are particularly suited for use in connection with HVAC plumbing. However, such crimp fittings often rely on the use of O-rings or other types of sealing elements that are not capable of resisting high temperatures. Thus, such fittings are not well suited for use in connection with OXY-MED plumbing that are required to withstand a pressure of 300 psi (2.07 MPa) after experiencing temperatures in excess of 1,000° F. (538° C.). At such temperatures, polymeric materials melt and/or become ineffective at maintaining pressure seals.

OXY-MED plumbing is typically required to operate at maximum pressures of less than 100 psi (0.69 MPa). However, because OXY-MED lines contain pressurized oxygen, the building codes and specifications require such lines to be capable of withstanding the high temperatures associated with minor fires. Additionally, because at least some of such oxygen is ultimately inhaled, there are typically strict requirements related to the cleanliness of the tubing and joints used in OXY-MED plumbing. Thus, the fittings and tubing used must be formed out of materials that can be cleaned and that do not pose any health risks, and that can withstand an oxygen rich environment. Often, the tubes used in OXY-MED plumbing are hard drawn copper and the joints or other fittings are soldered or brazed. While conventional soldering/brazing techniques can be used to join some of such tubes (copper tubes in particular), soldering or brazing can have disadvantages. For example, soldering/brazing typically involves the use of a torch, which creates an inherent fire risk during installation. This can be problematic or prohibited in situations where tubes need to be joined in buildings while such buildings are open to the public. In addition, a protective gas must be charged into the connection before brazing to prevent oxidization of the interior surfaces and contamination of the OXY-MED plumbing lines.

### SUMMARY OF THE INVENTION

The present invention allows tubes to be connected to each other using a crimping technique rather than a soldering or brazing technique. Moreover, the fittings in accordance with the present invention utilize metal-to-metal seals that are capable of maintaining pressure seals at pressures in excess of 300 psi (2.07 MPa) and withstanding temperatures in excess of 1000° F. (538° C.). That being said, the fittings, although particularly suited for use in connecting OXY-MED tubes, can also be useful in connecting other types of plumbing such as water lines. The fittings are preferably annealed and used to join hardened tubes.

In one aspect of the invention, a crimp fitting comprises a monolithic and homogeneous female socket that is configured to receive and be crimped to an end portion of a tube. The socket comprises an annular wall and an axial opening. The annular wall comprises an inner cylindrical surface portion and at least one annular sealing portion that protrudes radially inward from axially adjacent portions of the annular wall. The cylindrical surface portion lies axially between the opening and the annular sealing portion, and has a diameter matched to the OD of the tube to which the fitting is configured to connect. The annular sealing portion has an innermost diameter that is greater than the diameter of the cylindrical surface portion. In view of this geometry, as the end of the tube is inserted into the socket, the tube cannot slideably contact the annular sealing portion. Thus, the annular sealing portion will not be damaged by the insertion of the end of the tube. Thereafter, the annular sealing portion is radially crimped inwards and ultimately contacts and deforms a portion of the tube in a manner creating interlocking geometry and a pressure seal.

In another aspect of the invention, a crimp fitting comprises a monolithic and homogeneous female socket that is configured to receive and be crimped to an end portion of a tube. The socket comprises an annular wall and an axial opening. The annular wall comprises an inner cylindrical surface portion and an axially serrated inner surface portion. The cylindrical surface portion lies axially between the opening and the axially serrated inner surface portion. The axially serrated inner surface forms a plurality of annular sealing portion protrusions.

Yet another aspect of the invention pertains to a method of crimping a monolithic and homogeneous female socket portion of a crimp fitting to an end portion of a tube. The socket portion comprises an annular wall and an axial opening. The annular wall comprises an inner cylindrical surface portion and at least one annular sealing portion. The cylindrical surface portion lies axially between the opening and the annular sealing portion, and has a diameter matched to the OD of the tube to which the fitting is configured to connect. The annular sealing portion has an inward facing surface that has an innermost diameter that is initially greater than the diameter of the cylindrical surface portion. The method comprises inserting the end portion of the tube into the socket portion of the crimp fitting through the axial opening of the socket portion. In view of fact that the end portion of the tube has a diameter that is approximately equal to the diameter of the inner cylindrical surface portion of the socket portion, the end portion of the tube is coaxial to the cylindrical surface portion and passes through the annular sealing portion without contacting the annular sealing portion. The method thereafter comprises crimping the socket portion of the crimp fitting in a manner such that the innermost diameter of the annular sealing portion reduces and the annular sealing portion contacts the end portion of the tube, thereby creating a permanent necked-in region in the end portion of the tube. The crimping also occurs in a manner such that, when the crimping is completed, the necked-in region in the end portion of the tube and the annular sealing portion of the socket portion remain radially compressed against each other.

Further features and advantages of the present invention, as well as the operation of the invention, are described in detail below with reference to the accompanying drawings.

### BRIEF DESCRIPTION OF THE DRAWINGS

FIG. 1 is a perspective view of a fitting in accordance with the invention, which is configured to join two equal diameter tubes to each other.

FIG. 2 is a top view of the fitting shown in FIG. 1.

FIG. 3 is a cross-sectional view of the fitting shown in FIGS. 1 and 2, taken about the line 3-3 of FIG. 2.

FIG. 4 is a detail view of FIG. 3.

FIG. 5 is a perspective view showing two tubes inserted into the fitting shown in FIGS. 1-4.

FIG. 6 is a cross-sectional view of the assembly shown in FIG. 5.

FIG. 7 is a cross-sectional view depicting the assembly shown in FIGS. 5 and 6 after the fitting has been crimped.

Reference numerals in the written specification and in the drawing figures indicate corresponding items.

### DETAILED DESCRIPTION

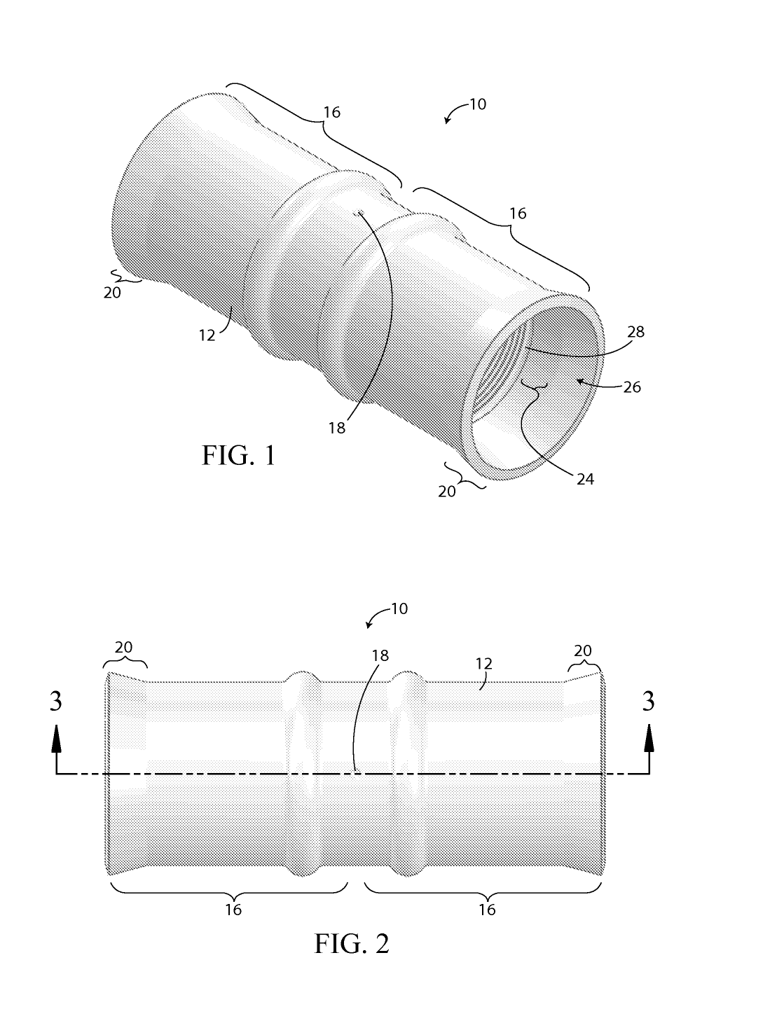

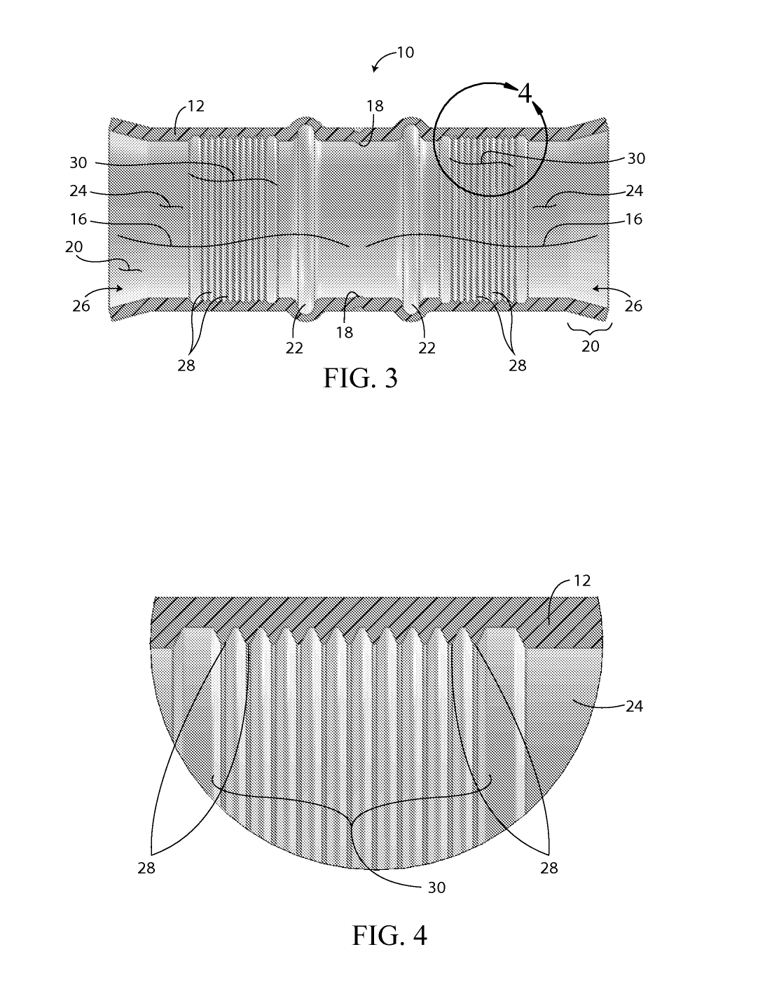

A crimp fitting in accordance with the invention is shown in FIGS. 1-4. The crimp fitting 10 shown is of the type that is configured to join two equal diameter tubes to each other. However, it should be appreciated that other fittings in accordance with the invention could also be configured to join two or more tubes of differing diameters, or could be an integral portion of the end of a tube that is configured to receive the end of another tube. Thus, the invention is not limited to the particular embodiment of the invention shown in the figures.

The fitting 10 is primarily formed via a single monolithic annular wall 12, but may also comprise one or more brazing rings 14 configured to melt when the fitting is subjected to fire, or one or more O-rings made of a material which can withstand temperatures up to 1000° F. (538° C.) without losing elasticity. The annular wall 12 of the fitting 10 forms a female socket 16 in each of its axially opposite halves. The annular wall 12 is preferably formed from a section of cylindrical copper-alloy tubing. A dimple insertion stop 18 is preferably press-formed into the top and bottom of annular wall 12 of the fitting 10 at its plane of axial symmetry. Each female socket 16 preferably comprises a flare 20 and a brazing ring channel 22 formed into the annular wall 12 of the fitting 12. The flare 20 extends from a cylindrical portion 24 of the respective socket 16 and flares radially outward as it extends to the opening 26 of the socket. The brazing ring channel 22 and the flare 20 are preferably formed using a hydroforming technique. One or more annular sealing protrusions 28 are formed on the inner surface of the annular wall 12, preferably between the brazing ring channel 22 and the cylindrical portion 24 of each socket 16. The annual sealing protrusions 28 are preferably formed by cutting grooves into portions of the annular wall 12 between the sealing protrusions, and preferably each socket 16 comprises a series of such sealing protrusions that form an axially serrated portion 30 within each socket. The grooves may be semi-circular, V-shaped, or square, or any other shape desired. Additionally, rather than forming a series of sealing protrusions 28 that are transverse to the center axis of the fitting 10, axially serrated portion 30 within each socket 16 could be formed by cutting a helical groove into the annular wall 12 (thereby forming a helical sealing protrusion). The depth of the grooves is preferably in the range of 0.010 and 0.015 inches (approximately 0.25 to 0.38 mm). The annular wall 12 of the fitting 10 is preferably annealed to a soft temper with a grain size between 0.005 mm and 0.070 mm.

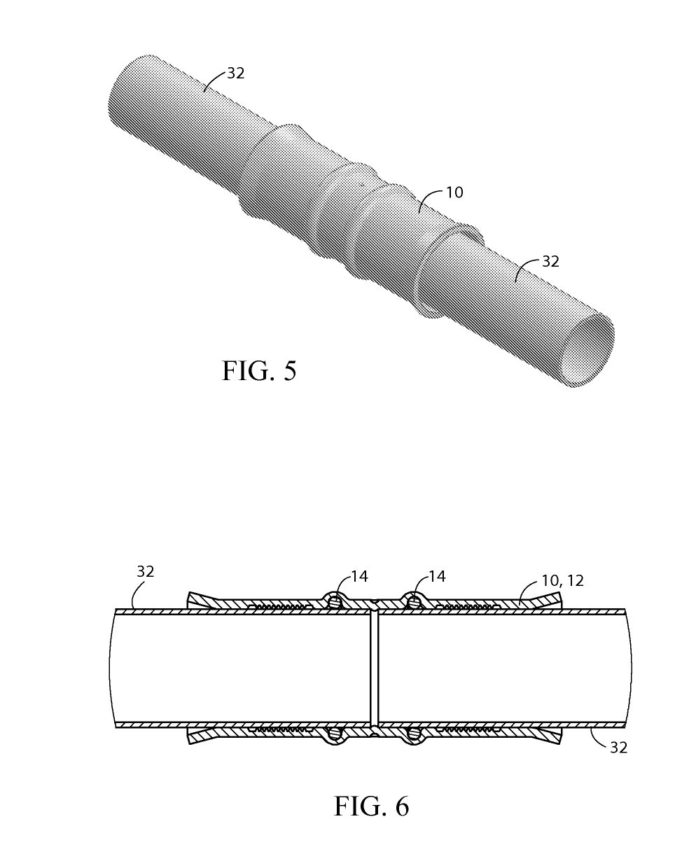

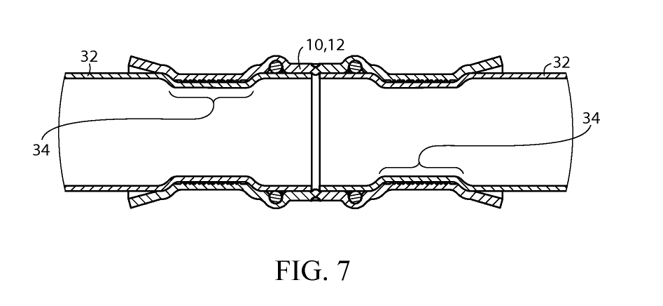

As is noticeable in FIG. 4, each of the annular sealing protrusions 28 of the serrated portion 30 of each socket 16 has an innermost diameter that is slightly greater than the adjacent cylindrical portion 24 of the socket. This ensures that, as the end portion of a tube 32 is inserted into the socket 16 (as shown in FIGS. 5 and 6), the tube does not contact the sealing protrusions. Of course, that is because the cylindrical portion 24 has a diameter that fits snugly around the end portion of the tube 32. As such, the sealing protrusions 28 cannot be damaged by the insertion of the end portion of the tube 32. Prior to inserting the end portion of the tube 32 into one of the sockets 16, the grooves between sealing protrusions 28 of that socket are preferably filled with a high temperature sealant (not shown), such as Superior Seal & Assist #5000 produced by Superior Industries. Shortly thereafter, the end portion of the tube 32 is inserted into said the socket 16. Upon contacting the dimple insertion stops 18, the end portion of the tube 32 is fully inserted into the fitting 10 and the female socket 16 can then be crimped. The crimping process is preferably performed in a generally uniform manner, as is described in U.S. patent application Ser. No. 13/714,002. The radially outward extending bulge created by the formation of the brazing ring channel 22 and the flare 20 of the female socket 16 preferably serve as guides between which the crimper straddles the fitting 10 during the crimping process. This ensures that the crimper is axially located in the most ideal location along the female fitting 16. Preferably the crimper only crimps the annular wall 12 in the region of the sealing protrusion 28 or serrated portion 30 of the female fitting 16. As this occurs, the soft (annealed) sealing protrusion(s) 28 radially conforms against the end portion of the hard tube 32 and a corresponding portion 34 of the end portion of the tube 32 necks-in as shown in FIG. 7. Simultaneously, the crimping also causes the sealant to flow out of the grooves between the sealing protrusions 28 and into the spaces radially between the sealing protrusions and the end portion of the tube 32. The crimping also causes the crimped portion of the annular wall 12 to work harden. Because the fitting 10 is initially annealed and work hardens during the crimping process and the end portion of the tube 32 is fully hard, after crimping, the necked-in portion 34 of the end portion of the tube 32 will remain radially biased against the sealing protrusion(s) 28 with a radial compression force that creates a pressure seal sufficient to withstand a pressure differential in excess of 300 psi (2.07 MPa). It should also be appreciated that the crimping creates interlocking geometry between the fitting 10 and the end portion of the tube 32 that prevents the end portion of the tube 32 from thereafter pulling axially out of the fitting. Still further, it should be appreciated that the sealant is configured to remain liquid or pliable when at high temperatures in a manner such that the sealant will not crack should the fitting axially expand in a fire. Thus, the sealant provides additional sealing capability in the event of fire.

As mentioned above, a brazing ring 14 can also be positioned in the respective brazing ring channel 22 prior to inserting the end portion of the tube 32 into the respective female socket 16 of the fitting 10. The purpose of the brazing ring 14 is not to be brazed when forming the joint between the fitting 10 and the end portion of the tube 32. Instead, the brazing ring 14 acts as a backup sealing means in the event the joint is subjected to fire or other abnormally high temperatures. When the joint is subjected to such fire or other abnormally high temperatures, the brazing ring 14 will melt and form an additional barrier to gas leaks. An alternative to brazing rings 14 are the high temperature O-rings discussed above. If such high temperature O-rings are used, a crimping tool may be configured to apply lesser compressive forces onto exterior portions of the annular wall 12 that encircle the channels 22 during the process of crimping the fitting 10. Doing so would increase the compression of the O-rings and improve the effectiveness of the O-rings. However, like the brazing rings 14, the purpose of the O-rings would be to provide backup sealing means in the event the joint is subjected to fire or other abnormally high temperatures. In either case, the crimping process is preferably performed in a generally uniform manner, as is described in U.S. patent application Ser. No. 13/714,002.

In view of the foregoing, it should be appreciated that the invention achieves the several advantages over prior art fittings.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A crimp fitting comprising a monolithic and homogeneous female socket configured to receive and be crimped to an end portion of a tube, the socket comprising an annular wall and an axial opening, the annular wall comprising an inner cylindrical surface portion and at least one annular sealing portion that protrudes radially inward from axially adjacent portions of the annular wall, the cylindrical surface portion having a diameter and being axially between the opening and the annular sealing portion, the annular sealing portion having an innermost diameter that is greater than the diameter of the cylindrical surface portion.

2. A crimp fitting in accordance with claim 1 wherein the female socket is formed of a metal comprising copper and the female socket is in an annealed condition.

3. A crimp fitting in accordance with claim 1 wherein the at least one annular sealing portion is one of a plurality of axially adjacent similar annular sealing portions.

4. A crimp fitting in accordance with claim 1 wherein the annular wall further comprises a brazing ring channel and the crimp fitting further comprises a brazing ring, the brazing ring channel protruding radially outward into the socket, the brazing ring being positioned in the brazing ring channel and being formed of a material having a lower melting point than that of the socket.

5. A crimp fitting in accordance with claim 4 wherein the annular sealing portion is positioned axially between the brazing ring channel and the cylindrical surface portion.

6. A crimp fitting in accordance with claim 1 wherein the annular wall further comprises an O-ring channel and the crimp fitting further comprises an O-ring, the O-ring channel protruding radially outward into the socket, the O-ring being positioned in the O-ring channel and being formed of elastic material that can withstand 1000° F. (538° C.) without losing elasticity.

7. A crimp fitting in accordance with claim 1 wherein the annular wall flares radially outward from the cylindrical surface portion to axial opening of the socket.

8. A crimp fitting comprising a monolithic and homogeneous female socket configured to receive and be crimped to an end portion of a tube; the socket comprising an annular wall and an axial opening, the annular wall comprising an inner cylindrical surface portion and an axially serrated inner surface portion, the cylindrical surface portion being axially between the opening and the axially serrated inner surface portion, the axially serrated inner surface forming a plurality of annular sealing portion protrusions.

9. A crimp fitting in accordance with claim 8 wherein the serrated inner surface portion forms a plurality of axially adjacent annular protrusions and annular channels that alternate with each other.

10. A crimp fitting in accordance with claim 8 wherein the female socket is formed of a metal comprising copper and the female socket is in an annealed condition.

11. A crimp fitting in accordance with claim 8 wherein the annular wall further comprises a brazing ring channel and the crimp fitting further comprises a brazing ring, the brazing ring channel protruding radially outward into the socket, the brazing ring being positioned in the brazing ring channel and being formed of a material having a lower melting point than that of the socket.

12. A crimp fitting in accordance with claim 11 wherein the serrated inner surface portion is positioned axially between the brazing ring channel and the cylindrical surface portion.

13. A crimp fitting in accordance with claim 1 wherein the annular wall further comprises an O-ring channel and the crimp fitting further comprises an O-ring, the O-ring channel protruding radially outward into the socket, the O-ring being positioned in the O-ring channel and being formed of elastic material that can withstand 1000° F. (538° C.) without losing elasticity.

14. A crimp fitting in accordance with claim 8 wherein the annular wall flares radially outward from the cylindrical surface portion to axial opening of the socket.

15. A method of crimping a monolithic and homogeneous female socket portion of a crimp fitting to an end portion of a hardened tube, the socket portion comprising an annular wall and an axial opening, the annular wall comprising an inner cylindrical surface portion and at least one annular sealing portion, the cylindrical surface portion having a diameter and being axially between the opening and the annular sealing portion, the annular sealing portion having an inward facing surface that has an innermost diameter that is initially greater than the diameter of the cylindrical surface portion, the annular wall of the fitting being annealed, the method comprising;
inserting the end portion of the tube into the socket portion of the crimp fitting through the axial opening of the socket portion, the end portion of the tube having a diameter that is approximately equal to the diameter of the inner cylindrical surface portion of the socket portion in a manner such that the end portion of the tube is coaxial to the cylindrical surface portion and passes through the annular sealing portion without contacting the annular sealing portion; and thereafter
crimping the socket portion of the crimp fitting in a manner such that the innermost diameter of the annular sealing portion reduces and the annular sealing portion contacts the end portion of the tube in a manner creating a permanent necked-in region in the end portion of the tube, the crimping also occurring in a manner such that, when the crimping is completed, the necked-in region in the end portion of the tube and the annular sealing portion of the socket portion remain radially compressed against each other.

16. A method in accordance with claim 15 wherein the socket portion is formed of a metal comprising copper and is initially in an annealed condition, and the crimping causes the annular sealing portion of the socket portion to work harden.

17. A method in accordance with claim 15 wherein the cylindrical surface portion has a diameter after crimping that is the same as its diameter prior to crimping.

18. A method in accordance with claim 15 wherein the socket portion comprises a groove on at least one side of the annular sealing portion that extend radially outward into the annular wall, and the method further comprises at least partially filling the groove with sealant prior to inserting the end portion of the tube into the socket portion of the crimp fitting.
